(19) United States
(12) Patent Application Publication
(10) Pub. No.: US 2007/0187240 A1
(43) Pub. Date: Aug. 16, 2007

(54) Gas sensor, gas concentration detecting system and related manufacturing method

(75) Inventors: Kenichi Araya, Oobu-shi (JP); Tooru Katafuchi, Aichi-ken (JP); Kazuhiro Okazaki, Aich-ken (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/702,113

(22) Filed: Feb. 5, 2007

(30) Foreign Application Priority Data
Feb. 13, 2006 (JP) 2006-035398

(51) Int. Cl. G01N 27/26

(52) U.S. Cl. 204/424

(57) ABSTRACT

A gas sensor, a gas concentration detection system and a method of manufacturing the gas concentration detection system are disclosed. A gas sensor carries an individual information identifying section, which stores unique individual information related to the gas sensor. The individual information identifying section includes a two-dimensional information code readable with an image recognition device. The individual information identifying section includes a two-dimensional information code readable with an image recognition device. The gas concentration detecting system comprises, in addition to the gas sensor and the image recognition device, an engine control unit operative to correct a sensor output readout value, which is actually read out from the gas sensor, depending on information related to a sensor output value included in the information code.

### CROSS REFERENCE TO RELATED APPLICATIONS

This application is based on Japanese Patent Application No. 2006-35398, filed on Feb. 13, 2006, the content of which is hereby incorporated by reference.

### BACKGROUND OF THE INVENTION

1. Field of the Invention

The present invention relates to gas sensors for detecting gas concentrations and, more particularly, to a gas sensor, a gas concentration detecting system and a related manufacturing method for manufacturing the gas concentration detecting system for detecting specified gas concentration of measuring gases in an internal combustion.

2. Description of the Related Art

In general, modern internal combustion engines such as a gasoline engine or diesel engine usually have exhaust systems on each of which gas sensors are mounted for measuring an oxygen concentration of exhaust gases. The gas sensors include an air fuel ratio (A/F) sensor or O₂ sensor for measuring an oxygen concentration of exhaust gases to detect an air fuel ratio in the engine or a constituent detecting sensor configured to detect a concentration of specified gas such as NOX, HC or CO contained in exhaust gases.

With the gas sensors manufactured even in the same specification, variations take place in sensor output values, generated when measuring an oxygen concentration, depending on individual variability present among various components parts forming the gas sensor. For the purpose of minimizing adverse affects resulting from such variations on the sensor output value, the gas sensors are provided with discrimination resistances that reflect error deviations caused in the sensor output values. An engine control unit, needed to provide a sensor output value in high precision, includes an electrical circuit arranged to correct the output value of the gas sensor using a resistance value of the discrimination resistance. This enables the engine control unit to precisely control a fuel injection rate needed for an intake air volume with the resultant advantageous effect with the improvement over exhaust gas emission and fuel consumption. The sensor output value of the gas sensor is corrected using such a discrimination resistance in technologies disclosed in, for instance, Japanese Unexamined Patent Application Nos. 11-281617 and 2005-315757.

The gas sensors of the related art using the discrimination resistances encounter various issues as described below.

That is, with technology of indicating the error deviation based on the sensor output value using a resistance value of the discrimination resistance, there exists a limitation in indicating a kind of error deviations due to a difference in magnitude of the resistance values. Therefore, the gas sensor of the related art has encountered a difficulty in performing management of a wide variety of individual information. In addition, the gas sensor employing the discrimination resistance has a limitation in precision even after the sensor output value has been corrected. Thus, in a case where further increased precision is required, a kind of discrimination resistance increases causing an increase in manufacturing cost and a difficulty has been encountered in performing management on production.

Moreover, under a situation where the discrimination resistance is provided on a connector section to which lead portions extracted from the gas sensor are connected, the connector section becomes complicated in structure, causing an issue with an increase in manufacturing cost.

The present invention has been completed with the above view in mind and has an object to provide a gas sensor, a gas concentration detecting system, using such a gas sensor, and a related manufacturing method which enables an individual information identifying section to store an increased volume of individual information while making it possible to form the individual information identifying section in a simplified structure with low production cost.

To achieve the above object, a first aspect of the present invention provides a gas sensor which comprises a gas sensor body for detecting a gas concentration in measuring gases, and an individual information identifying section, associated with the gas sensor body, which stores individual information related to the gas sensor. The individual information identifying section includes a two-dimensional information code readable with an image recognition device.

With the gas sensor according to the first aspect of the present invention, the individual information identifying section comprises the two-dimensional information code that stores individual information specific to the gas sensor. Therefore, the information code can store a wide variety of individual information on the gas sensor. This allows the individual information identifying section to store an increased volume of individual information.

Further, using the information code for the gas sensor according to the present invention results in capability of forming the individual information identifying section in a simplified structure without causing the individual information identifying section to be complicated in structure.

Therefore, with the gas sensor according to the present invention, the individual information identifying section can store the increased volume of individual information specific to the gas sensor, thereby enabling the individual information identifying section to be formed in a simplified structure.

A second aspect of the present invention provides a gas concentration detecting system, comprising a gas sensor for detecting a gas concentration in measuring gases and having an individual information identifying section including an information code which stores individual information related to the gas sensor, an image recognition device operative to read out the individual information from the information code, and an engine control unit operative to correct a sensor output readout value, which is actually read out from the gas sensor, depending on information related to a sensor output value included in the information code.

According to the second aspect of the present invention, the gas concentration detecting system employs the gas sensor formed in a structure provided with the individual information identifying section composed of the two-dimensional information code that can minimizes adverse affects in detecting the gas concentration due to an individual difference resulting from the gas sensors.

With the gas concentration detecting system of the present embodiment according to the present invention, more particularly, the engine control unit of the internal combustion engine corrects the sensor output readout value, to be actually read out from the gas sensor, depending on information related to the sensor output value serving as individual information of the gas sensor contained in the information code. The sensor output readout value can be accurately corrected through the use of the information code that can store a wide variety of information.

Therefore, the second aspect of the present invention enables the gas concentration detecting system to perform the operation to detect gas concentration.

A third aspect of the present invention provides a method of manufacturing a gas concentration detecting system adapted to detect a gas concentration in measuring gases, comprising the steps of reading out individual information from an information code of a gas sensor with a computer using an image recognition device, and writing the individual information, read out by the computer, into an engine control unit, with which the gas sensor is associated, using a writing device.

With the manufacturing method according to the third aspect of the present invention, the gas concentration detecting system is manufactured using the gas sensor and the engine control unit upon correcting the sensor output value of the gas sensor using the gas sensor provided with the individual information identifying section composed of the two-dimensional information code or acquiring production information on the gas sensor.

With the manufacturing method according to the third aspect of the present invention, further, the gas concentration detecting system is manufactured using the image recognition device, the writing device and the computer. More particularly, the reading step and the writing step are carried out using the image recognition device, the writing device and the computer, upon which individual information on the gas sensor is input to the engine control unit to which the relevant gas sensor is mounted.

According to the third aspect of the present invention, therefore, the engine control system is available to correct the sensor output value of the gas sensor associated with the engine control unit or acquire production information of the gas sensor assembled to the engine control system, thereby manufacturing a highly reliable gas concentration detecting system.

### BRIEF DESCRIPTION OF THE DRAWINGS

For a better understanding of the present invention and to show how the same may be carried into effect, there will now be described by way of example only, specific embodiments according to the present invention with reference to the accompanying drawings, in which:

FIG. 1 is an illustrative view showing a gas sensor of a first embodiment according to the present invention;

FIG. 2 is an illustrative view showing a gas concentration detecting system employing the gas sensor of the first embodiment shown in FIG. 2 for typically illustrating how the gas concentration detecting system reads out information from an information code of the gas sensor and writes the resulting information in an engine control system;

FIG. 3 is a graph showing a characteristic of the gas sensor of the first embodiment, composed of a limiting current type gas sensor, in which an applied voltage is plotted on a transverse axis and a sensor output value, represented with a current value, which is plotted on a longitudinal axis;

FIG. 4 is a graph showing a relational map in which an air fuel ratio (A/F) of an engine is plotted on a transverse axis and a sensor output value (mA) is plotted on a longitudinal axis;

FIG. 5 is an illustrative view typically showing a storage status of unique individual information in an information code of the gas sensor of the first embodiment shown in FIG. 1;

FIG. 6 is an illustrative view showing a gas sensor of a second embodiment according to the present invention;

FIG. 7 is an illustrative view showing a gas sensor of a third embodiment according to the present invention;

FIG. 8 is a graph showing how variations of a sensor output readout value are improved using the gas sensor provided with the information code; and

FIG. 9 is a graph showing how the variations of the sensor output readout value are improved upon performing correcting operation using the information code and correcting operation using an atmospheric air learning method.

### DETAILED DESCRIPTION OF THE PREFERRED EMBODIMENTS

Now, gas sensors, gas concentration detecting systems of various embodiments according to the present invention and a related manufacturing method are described below in detail with reference to the accompanying drawings. However, the present invention is construed not to be limited to such embodiments described below and technical concepts of the present invention may be implemented in combination with other known technologies or the other technology having functions equivalent to such known technologies.

In the following description, like reference characters designate like or corresponding parts throughout the several views. Also in the following description, description on the same component parts of one embodiment as those of another embodiment is omitted, but it will be appreciated that like reference numerals designate the same component parts throughout the drawings.

Before entering into detailed description of various embodiments according to the present invention, general features of the various embodiments are described.

Firstly, the gas sensors of various embodiments will be described as gas sensors for detecting gas concentration of measuring gases. However, it will be appreciated that the gas sensor of the various embodiment may be utilized as, for instance, an air fuel ratio (A/F) sensor, an oxygen gas sensor, and a constituent detecting sensor for detecting NOx, HC, CO or the like contained in exhaust gases passing through an exhaust pipe of an automotive engine.

With the gas sensor according to the first aspect of the present embodiment, a two-dimensional information code may comprise a QR (Quick Response) code readable in first and second directions including a longitudinal direction and a lateral direction.

In such a case, the QR code has information arrayed in the longitudinal direction and the lateral direction, enabling a remarkable increase in the amount of information stored in the information code.

With the gas sensor according to the first aspect of the present invention, the individual information may include information related to a sensor output value which the gas sensor generates depending on variation in gas concentration to be detected.

With such an arrangement, using information related to the sensor output value specific to the gas sensor enables the engine control unit of the internal combustion engine to correct the sensor output value to be actually read out from the gas sensor. This makes it possible to allow the gas sensor to detect a gas concentration with improved detecting precision.

With the gas sensor according to the first aspect of the present invention, the information related to the sensor output value may include information as a sensor output correcting value representing at least one of a sensor output characteristic value of the gas sensor or a deviation of the sensor output characteristic value with respect to a theoretical sensor output value.

Here, the term “sensor output characteristic value” refers to a sensor output value directly output from the gas sensor. In addition, the term “theoretical sensor output value” refers to a theoretical sensor output value appearing when no individual variability (variation) is present in the sensor output characteristic value of the gas sensor.

Under a situation where information related to the sensor output value takes the sensor output characteristic value of the gas sensor, the sensor output characteristic value of the gas sensor can be directly stored on the information code. Meanwhile, Under a situation where information related to the sensor output value takes the sensor output correcting value of the gas sensor, the operation can be executed to preliminarily calculate a deviation quantity of the sensor output characteristic value with respect to the sensor output characteristic value, making it possible to store the resulting information in the information code.

With the gas sensor according to the first aspect of the present invention, the gas sensor may comprises a critical current type gas sensor, wherein the critical current type gas sensor includes a solid electrolyte body having an oxygen ion conductivity and having both sides formed with a pair of electrodes, respectively, to which a voltage is applied to cause critical current to flow such that a current value, flowing across the pair of electrodes, is measured for detecting an air fuel ratio in an internal combustion engine, and wherein the information on the sensor output value or the sensor output correcting value includes at least one of information on a point at a theoretical air fuel ratio region, information on a point in a rich fuel side region and information on a point in a lean fuel side region.

In such a case, the gas sensor of the limiting current type can correct the sensor output readout value on at least one point of a point on a theoretical air fuel ratio, a point on a rich fuel-side region and a point on a lean fuel-side region. This enables the improvement in detecting precision of an air fuel ratio of an internal combustion engine.

With the gas sensor according to the first aspect of the present invention, the gas sensor may comprises an oxygen concentration electromotive force type gas sensor, wherein the oxygen concentration electromotive force type gas sensor includes a solid electrolyte body having an oxygen ion conductivity and having both sides formed with a pair of electrodes, respectively, between which an electromotive force appears depending on a difference in an oxygen concentration and is measured for detecting an air fuel ratio in an internal combustion engine, and wherein the information on the sensor output value or the sensor output correcting value includes at least one of information on a point in a rich fuel side region and information on a point in a lean fuel side region.

With such a structure, the oxygen concentration electromotive force type gas sensor can correct the sensor output readout value on at least one of the point at the rich-side fuel region and the point at the lean-side fuel region. This enables an air fuel ratio of an internal combustion engine to be detected with improved detecting precision.

With the gas sensor of the present embodiment, further, the individual information may include at least one of a responsiveness of the gas sensor, an internal resistance, a heater resistance and a sensor activity time.

With such a structure, the gas sensor can have improved sensor output characteristic in a reflection of at least individual variability of responsiveness, internal resistance (element impedance), heater resistance and sensor activity time. In addition, responsiveness, internal resistance (element impedance), heater resistance and sensor activity time can be treated as information on a correcting value reflecting individual variability of the gas sensor.

Further, the correcting value on responsiveness can be used in, for instance, correcting time constant of responsiveness. Moreover, the correcting values on internal resistance, heater resistance and sensor activity time can be used in, for instance, correcting timing at which the gas sensor begins to detect a gas concentration.

In addition, here, the term “sensor activity time” refers to time needed for the gas sensor becomes available to appropriately detect a gas concentration on a stage after the gas sensor begins to operate.

With the gas sensor of the present embodiment, furthermore, the individual information may include production information of the gas sensor.

With such a structure, the gas sensor can store a wide variety of product information such as a part number, a serial number and the like as information mentioned above.

With the gas sensor of the present embodiment, the gas sensor body may have a lead wire section having a distal end coupled to a connector, wherein the individual information is provided on at least one of the lead wire section and the connector.

Such an arrangement enables the information code to be easily placed in any part of the gas sensor.

With the gas sensor according to the second aspect of the present invention, the engine control unit may be configured in a structure so as to measure an on-endurance sensor output value, resulting from measuring atmospheric air as measuring gas, when the gas sensor is used for a given period of time after the sensor output readout value has been corrected for thereby correcting the sensor output readout value again using the on-endurance sensor output value.

With such a structure, the engine control unit can operate so as to correct a sensor output value when mounting a gas sensor to an internal combustion engine after which even when detecting a gas concentration, a sensor output readout value can be corrected.

Upon using the gas concentration detecting system using the gas sensor for an extended period of time with the resultant elapse of endurance, the gas sensor encounters various deteriorations, causing variations to occur in the sensor output value of the gas sensor. When this takes place, the engine control unit operates to detect a gas concentration of measuring gas composed of atmospheric air to allow the resulting sensor output value to be treated as an on-on-endurance sensor output value. Then, the engine control unit further operates to correct the sensor output readout value again using such an on-endurance sensor output value.

By so doing, the engine control unit can perform reliable operation even after endurance degradation whereby the gas concentration detecting system can detect the gas concentration in high detecting precision.

With the manufacturing method of a third aspect of the present invention, the information code may store information related to a sensor output value as a sensor output correction value X representing a deviation value on a sensor output characteristic value Ib specific to the gas sensor in terms of a sensor output theoretical value Ia on a relational map, and the sensor output correction value X may be expressed as X=(Ib−Ia)/Ia×100 [%].

The use of the relational map stored in the information code enables the gas concentration detecting system to correct the sensor output value based on the sensor output correction value X expressed on the above formula. This increases the precision of the engine control unit to control an air fuel ratio of the engine.

### Embodiment

Now, a gas sensor 10 of a first embodiment according to the present invention, a gas concentration detection system using such a gas sensor 10 and a related manufacturing method are described below with reference to the accompanying drawings.

### First Embodiment

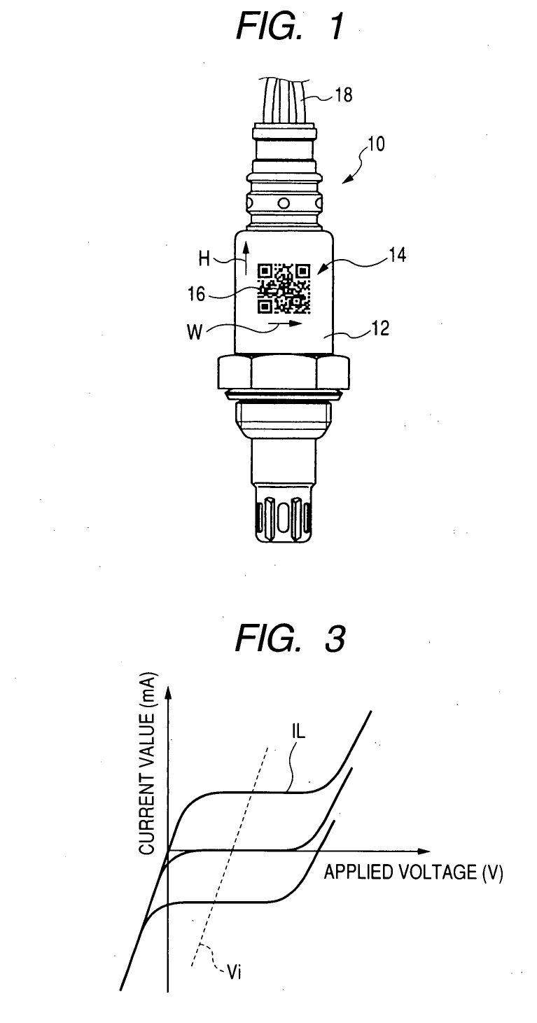

As shown in FIG. 1, the gas sensor 10 is shown as applied to an air-fuel ratio sensor that measures an oxygen concentration of measuring gas in exhaust gases passing through an exhaust system of an internal combustion engine (hereinafter referred to as an engine) for detecting an air-fuel ratio (that is, an A/F ratio representing a mixture ratio between air and fuel) of an air-fuel mixture in a combustion chamber of the engine. Further, the gas sensor 10 of the present embodiment comprises a gas sensor body 12 carrying thereon an individual information identifying section 14 that stores therein unique individual information specific to the gas sensor 12. The individual information identifying section 14 includes a two-dimensional information code 16 that is readable with an image recognition device in a manner as will be described below in detail.

Hereunder, the gas sensor 10 of the first embodiment, the gas concentration detection system and the related manufacturing method are described below with reference to FIGS. 1 to 8.

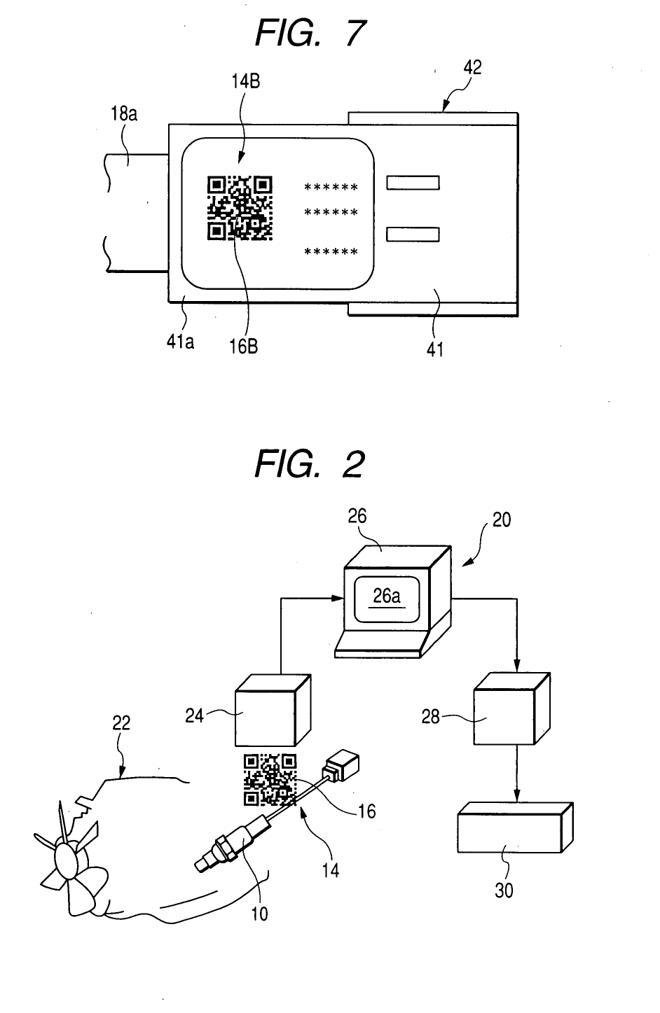

As shown in FIGS. 1 and 2, the information code 16 of the gas sensor 10 of the present embodiment is composed of a QR code including information arrayed in two directions such as a longitudinal direction H and a lateral direction W.

With the gas sensor 10 connected to a gas concentration detecting system 20, the gas sensor 10 is mounted on an exhaust system of an engine 22 at a position downstream of an exhaust port of a combustion chamber (not shown). When this takes place, individual information, stored in the information code 16 of the gas sensor 10, is read out with an image recognition device 24 in the two directions including the longitudinal direction H and the lateral direction W for recognition.

The gas sensor 10 of the present embodiment comprises a limiting current type gas sensor that is structured to detect an air-fuel ratio of the engine 22. The gas sensor 10 is mounted on an exhaust pipe of the exhaust system of the engine 22 and measures an oxygen concentration of measuring gas, appearing after combustion of an air fuel mixture, which passes through the exhaust pipe.

The gas concentration detection system 20 comprises, in addition to the image recognition device 24 adapted to identify the gas sensor 10 upon detecting individual information from the individual information identifying section 14 to deliver an output signal indicative thereof, a microcomputer 26 having a display 26a, a writing device 28 and an engine control unit (ECU) 30.

FIG. 3 is a view showing a characteristic of the current limiting type gas sensor 10 representing a critical current IL in terms of a current value (mA) plotted on a longitudinal axis and an applied voltage (V) plotted on a horizontal axis. The current limiting type gas sensor 10 comprises a solid electrolyte body, having an oxygen ion conductivity, which has both surfaces formed with electrodes in a pair. During operation of the gas sensor 10, a voltage Vi (V) is applied across the pair of electrodes to cause the critical current IL to flow, with the critical current IL (mA) being measured for thereby measuring an oxygen concentration of measuring gas.

In practical use, a vehicle is equipped with the gas concentration detection system 20 incorporating the gas sensor 10. With such an arrangement, an air fuel ratio detecting system (a gas concentration detecting system) is constructed, using the gas sensor 10, provided with the information code 16, and the engine control unit (ECU) 30, for detecting an air fuel ratio in the engine.

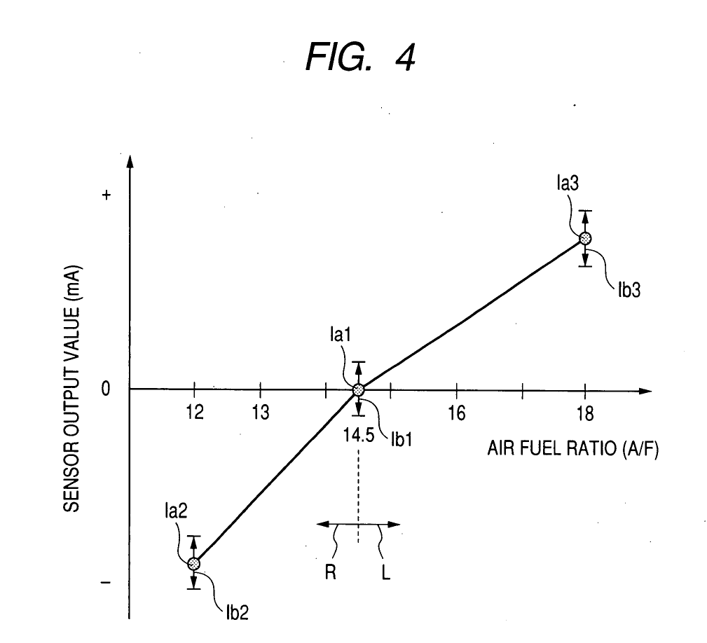

FIG. 4 is a graph representing a sensor output value (in a current value (mA) plotted on a longitudinal axis and an air-fuel ratio plotted on a horizontal axis and showing a relational map between a theoretical sensor output value Ia and an air-fuel ratio (A/F).

With the gas concentration detection system 20 shown in FIG. 2, the engine control unit 30 stores therein the relational map between a theoretical sensor output value Ia, appearing when no individual difference is present, and an air-fuel ratio (A/F) detected based on a level of the theoretical sensor output value Ia as shown in FIG. 4. This relational map is structured to enable the engine control unit 30 to calculate the air-fuel ratio of the engine on the basis of the theoretical sensor output value Ia detected by the gas sensor 10 using a mathematical formula expression such as a proportional relation.

With the present embodiment, further, the sensor output readout value is corrected using information related to the sensor output value contained in the information code 16 of the gas sensor 10, thereby correcting the relational map mentioned above.

The information code 16, placed on the gas sensor 10, stores information related to the sensor output value output from the gas sensor 10 depending on variation of the oxygen concentration being detected, and unique information specific to the gas sensor 10 including those such as product information or the like of the gas sensor 10.

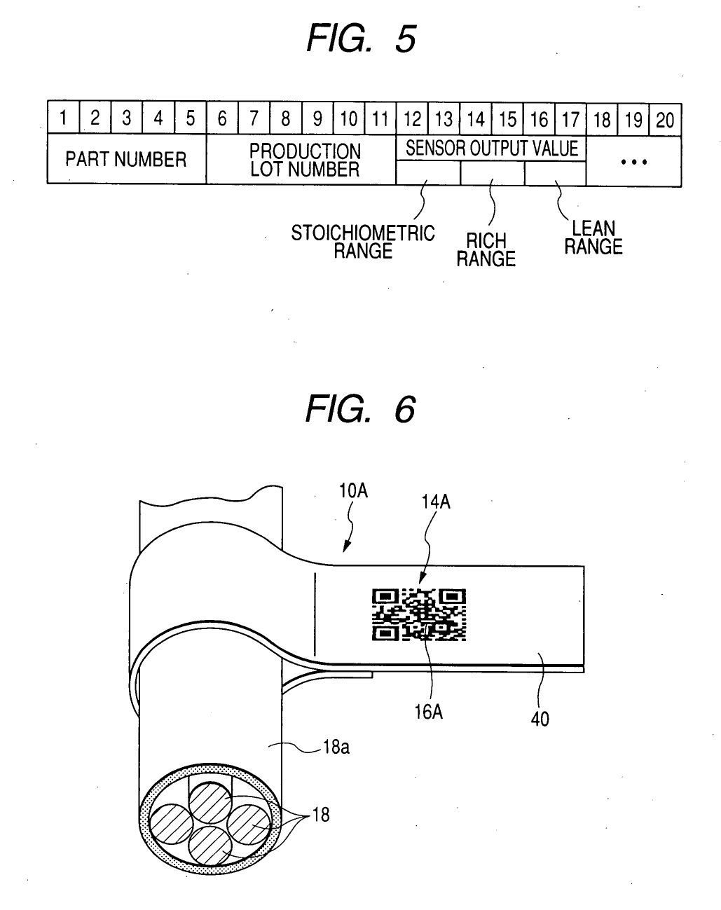

FIG. 5 is a view typically showing a storage state of unique information related to the information code 16 of the gas sensor 10 shown in FIG. 1. As shown in FIG. 5, the information code 16 has information, readable with the image recognition device 24, which is stored in, for instance, a memory that has addresses Nos. 1 to 5 for storing information on a part number, Nos. 6 to 11 for storing information on a lot serial number and Nos. 12 to 17 for storing sensor output values, related to a stoichiometric region, a rich-side region and a lean-side region, which are stored in the information code 16 as information for correcting the gas sensor output.

Further, in a case where the respective addresses are made available for storage in sixteen patterns from 0 to F, the information code 16 can store respective information such as, for instance, a theoretical air fuel ratio (stoichiometric) region, a rich fuel region and a lean fuel region in 256 patterns from 00 to FF.

Further, the information code 16 stores information related to a sensor output value as a sensor output correction value X representing a deviation value on the sensor output characteristic value Ib specific to the gas sensor 10 for the sensor output theoretical value Ia on the relational map set forth above. The sensor output correction value X is expressed as X=(Ib−Ia)/Ia×100 [%].

As shown in FIG. 4, with the gas sensor of the present embodiment, information on the sensor output correction value X are stored in the information code 16 as a sensor output correction value X1 on a point at a theoretical air fuel ratio (with A/F=14.5), a sensor output correction value X2 on a point (with A/F=13 in the present embodiment) on a rich fuel side area (A/F<14.5) in a fuel rich region FX, and a sensor output correction value X3 on a point (with A/F=18 in the present embodiment) on a lean fuel side area (A/F<14.5) in a fuel lean region FL.

As shown in FIG. 4, the relational map has a theoretical sensor output value Ia1 appearing at a point on a theoretical air fuel ratio, a theoretical sensor output value Ia2 appearing at a point on a rich air fuel ratio and a theoretical sensor output value Ia3 appearing at a point on a lean air fuel ratio. With the engine control unit 30 acquiring the sensor output correction values X1, X2, X3 from the information code 16 on the gas sensor 10, multiplying the sensor output correction values Ia1, Ia2, Ia3 by the sensor output correction values X1, X2, X3 allows the calculation of sensor output readout values subsequent to corrections to be actually read out with the engine control unit 30.

In such a way, the air fuel ratio detection system 20 of the present embodiment can calculate an air fuel ratio of an engine at the highest precision in proportion to the magnitude of the sensor output readout values after these values have been corrected using the corrected relational map.

In addition, the information code 16 may also store the sensor output characteristic value Ib specific for the gas sensor 10 as information related to the sensor output value. In such a case, the engine control unit 30 may be formed in a circuit configuration in which the sensor output correction value X is acquired to allow the sensor output readout values to be corrected (for correction of the relational map) in the same manner as that mentioned above.

Further, unique information to be stored in the information code 16 may include respective information such as responsiveness, internal resistance (element impedance), heater resistance or sensor activity time of the gas sensor 10.

Responsiveness of the gas sensor 10 may be stored in the information code 16 as a value indicating the degree of a delay in detecting an oxygen ion current in the gas sensor 10. With such an arrangement, the engine control unit 30 may be configured such that upon receipt of unique responsiveness specific to the gas sensor 10, a gas concentration can be detected on consideration of unique responsiveness of the gas sensor 10.

Internal resistance (element impedance) of the gas sensor 10 may be stored in the information code 16 as a value indicating unique resistance of the solid electrolyte body, on which a pair of electrodes are provided, unique resistances of the pair of electrodes and unique resistances of conductive parts. In addition, the gas sensor 10 may be provided with a heater so as to enable the gas sensor 10 to be controlled at a given temperature range such that the gas sensor 10 has a stabilized sensor output characteristic. With the gas sensor 10, internal resistance varies depending on operating temperatures of the gas sensor 10. Thus, during the operation to control the temperature of the gas sensor 10, a value of internal resistance of the heater is measured and operated under feedback control so as to maintain internal resistance at a given value. Therefore, the engine control unit 30 acquires unique internal resistance specific to the gas sensor 10, enabling the detection of a gas concentration of measuring gas in the light of unique internal resistance of the gas sensor 10.

The information code 16 may store heater resistance of the gas sensor 10 as a unique resistance value of a conducting type heater utilizing Joule heat of the gas sensor 10. The magnitude of heater resistance adversely affects warming performance of the gas sensor 10. Therefore, upon operation of the engine control unit 30 acquiring unique heater resistance specific to the gas sensor 10, the temperature of the gas sensor 10 can be reliably controlled I the light of unique heater resistance specific to the gas sensor 10.

The information code 21 may store the sensor activity time of the gas sensor 10 as a time value needed for the gas sensor 10 until the gas sensor 10 is capable to appropriately detect a gas concentration.

Turning back to FIG. 1, the gas sensor 10 has the information code 10 directly provided on the gas sensor body 12. The gas sensor body 12 is usually warmed up at temperatures ranging from, for instance, 300 to 500° C. Therefore, the information code 10 may be preferably provided on the gas sensor body 12 by direct printing or laser marking using ink with heat resistance.

With a modified form shown in FIG. 6, a gas sensor 10A has a plurality of lead portions 18 extending from a gas sensor body (of the same structure shown in FIG. 1) and accommodated in a tube 18a surrounding the bundled lead portions 18. A tape 40 is wrapped around the tube 18a of the lead portions 18 and provided with an individual information identifying section 14A including an information code 16A of the same type used for the information code 16 of the gas sensor 10 shown in FIG. 1. With such a structure, the information code 16A includes various data such as part number or the like that is printed on the tape 40.

FIG. 7 shows another modified form of the gas sensor 10 shown in FIG. 1. With another modification shown in FIG. 7, a tape 41 is attached to a connector 42 fixedly secured to a terminal end of the tube 18a and has an extension 41a on which an individual information identifying section 14B is provided and includes an information code 16B printed on the tape 41. In an alternative, the information code 16B may be directly provided on a surface of the connector 42 by printing or laser marking.

A method of manufacturing the air fuel ratio detection system of the present embodiment mentioned above is carried out by executing the following steps including individual information acquiring step, reading out step and writing step.

More particularly, first, individual information acquiring step is carried out. In this step, after the gas sensor 10 has been manufactured, individual information of the gas sensor 1 is measured with the resulting individual information being written in the information code 16. That is, manufacturing information (individual information), such as a part number and a production serial number or the like of the gas sensor 10, are written in the information code 16. In addition, upon production of the gas sensor 10, characteristic tests of the gas sensor 10 are conducted to measure operating characteristics such as a gas sensor output or the like of the gas sensor 10. Then, characteristic information (individual information) such as the gas sensor output or the like is written in the information code 16. Thereafter, the information code 16, in which a variety of individual information is written, is fitted to the gas sensor 10.

Further, individual information acquiring step is carried out on the gas sensor 10 on mass production of the gas sensors 10.

Next, reading out step and writing step are executed using the image recognition device 24, the writing device 28 and the microcomputer 26 associated with the image recognition device 24 and the writing device 28. FIG. 2 is the view typically showing how individual information is read out from the information code 16 on the gas sensor 10 and individual information is written in the engine control unit 30.

As shown in FIG. 2, reading out step is carried out using the image recognition device 24. More particularly, the image recognition device 24 reads out individual information from the information code 16, indicated on the gas sensor 10, and delivers readout data to the microcomputer 26. Subsequently, the writing device 28 is operated to execute writing step upon which individual information, read out from the information code 16, is written in the engine control unit 30 to be installed on a vehicle to which the gas sensor 10 is applied.

Further, the writing device 28 enables individual information to be written into a memory used in the engine control unit 30. Then, mounting the memory onto the engine control unit 30 enables individual information to be stored in the engine control unit 30.

Thereafter, with the gas sensor 10 and the engine control unit 30 assembled to the vehicle, the engine control unit 30 operates correcting the sensor output value of the gas sensor 10 assembled to the engine control unit 30 and acquiring a production serial number of the gas sensor 10 installed on the engine. Thus, the air fuel ratio detection system can be manufactured.

With the gas sensor 10 of the present embodiment, the information code 16, playing a role as the individual information identifying section 14, takes the form of the QR code that stores unique individual information specific to the gas sensor 10. Therefore, the information code 16 is available to store a wide variety of individual information on the gas sensor 10. This enables individual information to be stored in the individual information identifying section 14 in an increased volume.

Further, the use of the individual information identifying section 14 enables characteristic information, such as the sensor output or the like, of the gas sensor 10, and production information such as the part number and the production serial number or the like of the gas sensor 10 to be consolidated in a single information code 16. Therefore, the gas sensor 10 employing the information code 16 of the present embodiment allows the individual information identifying section 14 to be simpler in structure than that employing identifying resistor of the related art.

Furthermore, with the individual information identifying section 14 employing the information code 16, the individual information identifying sections 14 can be structured with increased versatility with no need to alter structures of the individual information identifying sections 14.

With the gas sensor 10 of the present embodiment, accordingly, the individual information identifying section 14 can have an increased volume of individual information to be stored and the individual information identifying section 14 can be formed in a simple structure with increased versatility.

Moreover, the air fuel ratio detection system of the present embodiment employs the gas sensor 10 structured with the individual information identifying section 14 including the information code 16 formed in a two-dimensional pattern, thereby providing a structure an individual difference of the gas sensor 10 has minimized adverse affect on the detection of an air fuel ratio in the engine.

When manufacturing the gas sensors 10 with the same specification on mass production, the sensor output values of the gas sensors 10 have individual differences even with the same specification due to an individual difference arising between component parts and assembling states of the component parts.

Therefore, the air fuel ratio detection system of the present embodiment is arranged to correct a deviation (difference) in an output unique value resulting from the gas sensor 10 with respect to the theoretical sensor output value Ia in the relational map set forth above using information of the sensor output correction value X serving as individual information of the gas sensor 10 contained in the information code 16, thereby correcting the sensor output readout value to be actually read out from the gas sensor 10 in the engine control unit 30. Then, the resulting sensor output readout value can be accurately corrected using the information code 16 available to store a wide variety of information.

Thus, the air fuel ratio detection system of the present embodiment provides improved accuracy in detecting an air fuel ratio.

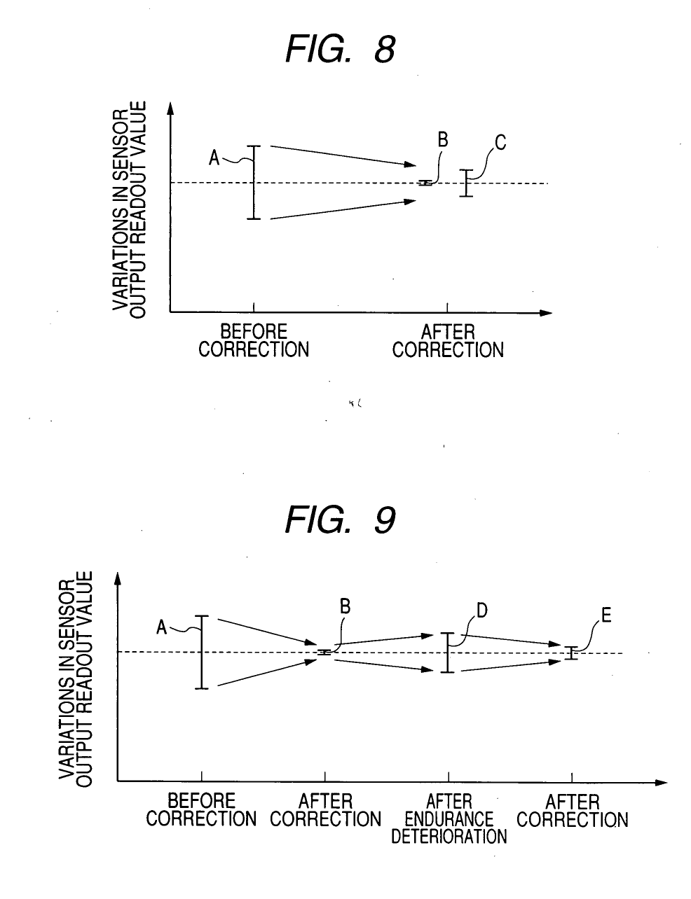

FIG. 8 is a graph showing variation in sensor output readout value, plotted in terms of a first status before correction and a second status after correction, for illustrating how the gas sensor 10 provided with the information code (QR code) 16 enables variation in s sensor output readout value to be actually read out with the engine control unit 30. In FIG. 8, reference character A represents variation in the sensor output readout value resulting from the gas sensor 10 before a status where the deviation in unique output value of the gas sensor is corrected on the basis of the theoretical sensor output value Ia of the relational map, shown in FIG. 4, and B represents variation in the sensor output readout value resulting from the gas sensor 10 after a status where the deviation in unique output value of the gas sensor is corrected on the basis of the theoretical sensor output value Ia of the relational map mentioned above. Reference character C represents variation in the sensor output readout value resulting from a gas sensor of the related art employing an identifying resistor.

With the gas sensor 10 of the present embodiment, the sensor output characteristic value Ib or the sensor output correction value X of the gas sensor 10 can be divided in stepwise changes with further fine precisions and input to the engine control unit 30. This allows the minimization of variation in the sensor output readout value. On the contrary, with the related art gas sensor employing the identifying resistor, the identifying resistor provides merely coarse stepwise precision and, hence, a difficulty is encountered in minimizing variation in the sensor output readout value.

In addition, the gas sensor 10 may comprise a gas sensor of an oxygen concentration electromotive force type formed in a structure including a pair of electrodes, formed on both sides of an electrolyte body having oxygen ion conductivity, which measure an electromotive force, occurring due to a difference in oxygen concentrations, for thereby detecting an air fuel ratio of the engine. In such a case, the sensor output characteristic value Ib or the sensor output correction value X to be stored in the information code 16 may include information related to a point on a rich fuel side region and a lean fuel side region, respectively.

### Second Embodiment

An air fuel ratio detection system of a second embodiment takes the form of a structure that performs not only a function to correct the sensor output readout value (based on the relational map) on a stage of assembling the gas sensor 10 onto a vehicle but also a function to correct a sensor output readout value using a so-called atmospheric learning method even when detecting the air fuel ratio using the gas sensor 10.

That is, the engine control unit (ECU) 30 of the present embodiment is configured in a circuit structure operative such that after the gas sensor 10 has been assembled to a vehicle with the sensor output readout value being corrected, the gas sensor 10 is used for a given period of time upon which an effort is made to measure an on-endurance sensor output value when the relevant gas sensor 10 measures measuring gas composed of atmospheric air whereby the sensor output readout value is corrected again using the corrected on-endurance sensor output value.

Meanwhile, with the air fuel ratio detection system employing the gas sensor 10 and operating for an extended period of use beyond a peak period, various deteriorations occur on the gas sensor 10 with the resultant adverse affect caused in accuracy of the sensor output value of the gas sensor 10. To address such an issue, the engine control unit 30 detects an oxygen concentration of measuring gas using atmospheric air as measuring gas to be detected with the gas sensor 10. In addition, an atmospheric state of measuring gas to be detected can be easily prepared by cutting off the supply of fuel being injected from a fuel injection device of an engine. Then, the engine control unit 30 corrects the sensor output readout value again using the on-endurance sensor output value.

By so doing, even the gas sensor 10 encounters endurance degradation, the air fuel ratio detecting system of the present embodiment can detect the air fuel ratio at a highly increased precision.

FIG. 9 is a graph showing variation in the sensor output readout value, obtained by the fuel ratio detection system, under a status appearing when correction is made using the information code (QR code) 16 and under a status appearing when correction is made using the atmospheric air learning method.

It will be concluded from FIG. 9 that although the gas sensor suffers from increased variations in the sensor output readout value after the endurance degradation as designated at D in the graph of FIG. 9, correcting the sensor output readout value using the atmospheric air learning method allows the sensor output readout value to be corrected again to the same minimum level E that is attained in using the information code 16 conducted on an initial assembling stage.

The air fuel ratio detection system of the present embodiment has the same advantages effects as those of the first embodiment.

While the specific embodiment of the present invention has been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalents thereof.

What is claimed is:

1. A gas sensor, comprising:
a gas sensor body for detecting a gas concentration in measuring gases; and
an individual information identifying section, associated with the gas sensor body, which stores individual information related to the gas sensor;
the individual information identifying section including a two-dimensional information code readable with an image recognition device.

2. The gas sensor according to claim 1, wherein:
the two-dimensional information code comprises a QR code readable in first and second directions including a longitudinal direction and a lateral direction.

3. The gas sensor according to claim 1, wherein:
the individual information includes information related to a sensor output value which the gas sensor generates depending on variation in gas concentration to be detected.

4. The gas sensor according to claim 1, wherein:
the information related to the sensor output value includes information as a sensor output correcting value representing at least one of a sensor output characteristic value of the gas sensor or a deviation of the sensor output characteristic value with respect to a theoretical sensor output value.

5. The gas sensor according to claim 1, wherein:
the gas sensor comprises a critical current type gas sensor;
wherein the critical current type gas sensor includes a solid electrolyte body having an oxygen ion conductivity and having both sides formed with a pair of electrodes, respectively, to which a voltage is applied to cause critical current to flow such that a current value, flowing across the pair of electrodes, is measured for detecting an air fuel ratio in an internal combustion engine; and
wherein the information on the sensor output value or the sensor output correcting value includes at least one of information on a point at a theoretical air fuel ratio region, information on a point in a rich fuel side region and information on a point in a lean fuel side region.

6. The gas sensor according to claim 4, wherein:
the gas sensor comprises an oxygen concentration electromotive force type gas sensor;
wherein the oxygen concentration electromotive force type gas sensor includes a solid electrolyte body having an oxygen ion conductivity and having both sides formed with a pair of electrodes, respectively, between which an electromotive force appears depending on a difference in an oxygen concentration and is measured for detecting an air fuel ratio in an internal combustion engine; and
wherein the information on the sensor output value or the sensor output correcting value includes at least one of information on a point in a rich fuel side region and information on a point in a lean fuel side region.

7. The gas sensor according to claim 1, wherein:
the individual information includes at least one of a responsiveness of the gas sensor, an internal resistance, a heater resistance and a sensor activity time.

8. The gas sensor according to claim 1, wherein:
the individual information includes production information of the gas sensor.

9. The gas sensor according to claim 1, wherein:
the gas sensor body has a lead wire section having a distal end coupled to a connector;
wherein the individual information is provided on at least one of the lead wire section and the connector.

10. A gas concentration detecting system, comprising:
a gas sensor for detecting a gas concentration in measuring gases and having an individual information identifying section including an information code which stores individual information related to the gas sensor;
an image recognition device operative to read out the individual information from the information code; and
an engine control unit operative to correct a sensor output readout value, which is actually read out from the gas sensor, depending on information related to a sensor output value included in the information code.

11. The gas concentration detecting system according to claim 10, wherein:
the engine control unit is configured in a structure so as to measure an on-endurance sensor output value, resulting from measuring atmospheric air as measuring gas, when the gas sensor is used for a given period of time after the sensor output readout value has been corrected for thereby correcting the sensor output readout value again using the on-endurance sensor output value.

12. A method of manufacturing a gas concentration detecting system adapted to detect a gas concentration in measuring gases, comprising the steps of:
preparing a gas sensor having an information code storing unique individual information;
reading out the individual information from the information code of the gas sensor with a computer using an image recognition device; and
writing the individual information, read out by the computer, into an engine control unit, with which the gas sensor is associated, using a writing device.

13. The method of manufacturing the gas concentration detecting system according to claim 12, wherein:
the information code stores information related to a sensor output value as a sensor output correction value X representing a deviation value on a sensor output characteristic value Ib specific to the gas sensor in terms of a sensor output theoretical value Ia on a relational map; and
wherein the sensor output correction value X is expressed as X=(Ib−Ia)/Ia×100 [%].
